(19) United States
(12) Patent Application Publication
(10) Pub. No.: US 2025/0070324 A1
(43) Pub. Date: Feb. 27, 2025

(54) SECONDARY BATTERY, BATTERY PACK, AND ENERGY STORAGE CABINET

(71) Applicants: ZHEJIANG JINKO ENERGY STORAGE CO., LTD., Zhejiang (CN); Jinko Energy Storage Technology Co., Ltd., Zhejiang Province (CN)

(72) Inventors: Xianrong ZENG, Zhejiang (CN); Yuhao WU, Zhejiang (CN)

(21) Appl. No.: 18/943,761

(22) Filed: Nov. 11, 2024

(30) Foreign Application Priority Data
Apr. 30, 2024 (CN) 202410538314.0
May 10, 2024 (CN) 202410581380.6

(51) Int. Cl. H01M 50/103; H01M 10/04; H01M 10/613; H01M 10/647; H01M 10/654; H01M 10/6554; H01M 10/6556; H01M 50/209

(52) U.S. Cl. CPC H01M 50/103; H01M 10/0431; H01M 10/613; H01M 10/647; H01M 10/654; H01M 10/6554; H01M 10/6556; H01M 50/209

(57) ABSTRACT

A secondary battery, a battery pack, and an energy storage cabinet. The secondary battery includes a case and a jelly roll arranged in an accommodating cavity of the case. Along a height direction of the secondary battery, a side of the jelly roll is provided with a bending section, a bottom wall of the case is provided with a first recessed portion recessed towards an interior of the secondary battery, and a first protruding portion is correspondingly formed at an inner side of the bottom wall. At least part of the bending section is located at a side of the first protruding portion along a width direction of the secondary battery. A contact area between the bottom wall and the jelly roll is increased, and a contact area between the heat exchange member and the secondary battery is increased, to improve heat dissipation efficiency.

### CROSS-REFERENCE TO RELATED APPLICATIONS

The present application claims priority to Chinese Application No. 202410538314.0, which is filed on Apr. 30, 2024, and Chinese Application No. 202410581380.6, which is filed on May 10, 2024, the contents of which are incorporated herein by reference in their entireties.

### TECHNICAL FIELD

The present disclosure relates to the technical field of energy storage, and in particular, to a secondary battery, a battery pack, and an energy storage cabinet.

### BACKGROUND

As a secondary battery is a rechargeable battery that can be reused and has reversibility and is a reversible battery that can continue to be used by recharging after the battery is discharged, the secondary battery generally includes a case, a cell assembly, and a top cover assembly. The top cover assembly and the case are configured to encapsulate the cell assembly. The cell assembly includes one or more jelly rolls. The secondary battery may generate heat during use. As the heat accumulates, operating efficiency of the secondary battery may be affected and there may be a safety risk.

### SUMMARY

The present disclosure provides a secondary battery, a battery pack, and an energy storage cabinet, aiming to improving the heat dissipation efficiency of the secondary battery.

An embodiment of the present disclosure provides a secondary battery, including: a case, including a side wall and a bottom wall that jointly enclose to define an accommodating cavity; and at least one jelly roll arranged in the accommodating cavity. Along a height direction of the secondary battery, at least one side of one of the at least one jelly roll is provided with a bending section; at least one first recessed portion is formed at a side of the bottom wall of the case facing away from an interior of the secondary battery, and the at least one first recessed portion is recessed towards the interior of the secondary battery; and a first protruding portion is formed at a side of the bottom wall facing the interior of the secondary battery; and at least part of the bending section is located at a side of the first protruding portion along a width direction of the secondary battery.

In an embodiment of the present disclosure, the at least one jelly rolls includes at least two jelly rolls sequentially arranged along the width direction of the secondary battery, and at least part of the first protruding portion extends between the bending sections of adjacent jelly rolls of the at least two jelly rolls.

In an embodiment of the present disclosure, the at least one first recessed portions includes at least three first recessed portions, one of which is located between the bending section and the side wall of the case, and/or one of the at least three first recessed portions is located between adjacent bending sections.

In an embodiment of the present disclosure, a cross section of the first recessed portion has a shape including at least one of a rectangle, an arc, or a triangle.

In an embodiment of the present disclosure, at least part of a surface of the first protruding portion fits the bending section.

In an embodiment of the present disclosure, along the height direction of the secondary battery, a depth of the first recessed portion ranges from 2 mm to 30 mm.

In an embodiment of the present disclosure, the case is provided with a second recessed portion, the second recessed portion is recessed along the height direction of the secondary battery, and the second recessed portion is located at each of two opposite sides of the bottom wall along the width direction of the secondary battery and passes through the side wall at a side of the case along the width direction of the secondary battery.

In an embodiment of the present disclosure, the secondary battery further includes a thermally conductive member. The thermally conductive member includes a first thermally conductive member, and the first thermally conductive member is located between the jelly roll and an inner wall of the case. The first thermally conductive member includes a first thermally conductive portion and a second thermally conductive portion connected to each other; along a length direction of the secondary battery and/or the width direction of the secondary battery, the first thermally conductive portion is located at a side of the jelly roll; and along the height direction of the secondary battery, the second thermally conductive portion is located at a side of the jelly roll facing the bottom wall of the case.

In an embodiment of the present disclosure, an area of a side of the jelly roll is a along the width direction of the secondary battery, an area of a side of the jelly roll is b along the length direction of the secondary battery, where a>b. The first thermally conductive portion is located at a side of the jelly roll along the width direction of the secondary battery.

In an embodiment of the present disclosure, the first thermally conductive member includes at least two first thermally conductive portions sequentially arranged along the width direction of the secondary battery, and the jelly roll is located between adjacent first thermally conductive portions of the at least two first thermally conductive portions.

In an embodiment of the present disclosure, the first thermally conductive member includes at least three first thermally conductive portions, and the at least one jelly roll includes at least two jelly rolls. Along an arrangement direction of the at least two jelly rolls, two opposite sides of each of the jelly rolls are each provided with the first thermally conductive portion.

In an embodiment of the present disclosure, the at least one jelly roll includes at least two jelly rolls sequentially arranged along the width direction of the secondary battery; and along the height direction of the secondary battery, projections of the at least two jelly rolls are located within a projection range of a same second thermally conductive portion.

In an embodiment of the present disclosure, the thermally conductive member includes at least one second thermally conductive member including a third thermally conductive portion and a fourth thermally conductive portion connected to each other, and the third thermally conductive portion and the fourth thermally conductive portion form at an angle. The jelly roll includes a roll structure and a tab connected to each other. The third thermally conductive portion is connected to the tab, the third thermally conductive portion is located between the tab and the roll structure, and the fourth thermally conductive portion is located between the jelly roll and the inner wall of the case.

In an embodiment of the present disclosure, the third thermally conductive portion is connected to the first thermally conductive portion, and/or the third thermally conductive portion is connected to at least one of the first thermally conductive portion and the second thermally conductive portion.

In an embodiment of the present disclosure, the thermally conductive member includes at least two second thermally conductive members, and the jelly roll includes a positive tab and a negative tab respectively connected to a corresponding second thermally conductive member.

In an embodiment of the present disclosure, a thickness of the first thermally conductive portion ranges from 0.1 mm to 4 mm, a thickness of the second thermally conductive portion ranges from 0.1 mm to 4 mm, a thickness of the third thermally conductive portion ranges from 0.05 mm to 2 mm, and a thickness of the fourth thermally conductive portion ranges from 0.1 mm to 4 mm.

An embodiment of the present disclosure provides a battery pack, including a battery module and a heat exchange member, the battery module including at least one secondary battery as described above. At least part of the heat exchange member is arranged at a side where the bottom wall of the secondary battery is located, and along the height direction of the secondary battery, the secondary battery is arranged above the heat exchange member. The heat exchange member includes a heat exchange channel, and at least part of the heat exchange channel is located in the first recessed portion.

In an embodiment of the present disclosure, the heat exchange member includes a body portion and a second protruding portion, the second protruding portion is arranged at a side of the body portion facing the secondary battery, at least part of the second protruding portion extends into the first recessed portion, and at least part of the heat exchange channel of the heat exchange member is arranged in the second protruding portion.

In an embodiment of the present disclosure, the secondary battery includes a second recessed portion, and the second recessed portions of adjacent secondary batteries are in communication with each other. The heat exchange member is provided with a third protruding portion that extends into the second recessed portion.

An embodiment of the present disclosure provides an energy storage cabinet, including an inverter, a battery management system, and the battery pack as described above.

Embodiments of the present disclosure provide a secondary battery, a battery pack, and an energy storage cabinet. The secondary battery includes a case and at least one jelly roll. The at least one jelly roll is arranged in an accommodating cavity of the case. Along a height direction of the secondary battery, a side of the jelly roll is provided with a bending section, a bottom wall of the case is provided with a first recessed portion recessed towards an interior of the secondary battery, and a first protruding portion is correspondingly formed at an inner side of the bottom wall. At least part of the bending section is located at a side of the first protruding portion along a width direction of the secondary battery. Through such a design, an area of contact between the bottom wall and the jelly roll can be increased. At the same time, the first recessed portion can be configured to accommodate a heat exchange member to increase an area of contact between the heat exchange member and the secondary battery, thereby helping improve heat dissipation efficiency of the secondary battery.

### BRIEF DESCRIPTION OF DRAWINGS

FIG. 1 is a schematic diagram of a secondary battery according to some embodiments of the present disclosure;

FIG. 2 is a sectional view of a secondary battery according to a first embodiment of the present disclosure;

FIG. 3 is a partial enlarged view of Position I shown in FIG. 2;

FIG. 4 is a sectional view of a secondary battery according to a second embodiment of the present disclosure;

FIG. 5 is a partial schematic diagram of a secondary battery according to a third embodiment of the present disclosure;

FIG. 6 is a partial schematic diagram of a secondary battery according to a fourth embodiment of the present disclosure;

FIG. 7 is a partial schematic diagram of a secondary battery according to a fifth embodiment of the present disclosure;

FIG. 8 is a partial sectional view of a secondary battery according to a sixth embodiment of the present disclosure;

FIG. 9 is a schematic diagram of a battery pack according to some embodiments of the present disclosure;

FIG. 10 is an exploded view of the battery pack according to some embodiments of the present disclosure;

FIG. 11 is a partial schematic diagram of a battery pack according to a first embodiment of the present disclosure;

FIG. 12 is a schematic diagram of a heat exchange member according to a first embodiment of the present disclosure;

FIG. 13 is a schematic diagram of a battery pack according to a first embodiment of the present disclosure;

FIG. 14 is a partial schematic diagram of a battery pack according to a second embodiment of the present disclosure;

FIG. 15 is a schematic diagram of a heat exchange member according to a second embodiment of the present disclosure;

FIG. 16 is a schematic diagram of a heat exchange member according to a third embodiment of the present disclosure;

FIG. 17 is a partial schematic diagram of a battery pack according to a third embodiment of the present disclosure;

FIG. 18 is a schematic diagram of a heat exchange member according to a fourth embodiment of the present disclosure;

FIG. 19 is a schematic diagram of an energy storage cabinet according to some embodiments of the present disclosure;

FIG. 20 is a schematic diagram of a secondary battery according to a seventh embodiment of the present disclosure;

FIG. 21 is a sectional view of a secondary battery according to an eighth embodiment of the present disclosure;

FIG. 22 is a sectional view of a secondary battery according to a ninth embodiment of the present disclosure;

FIG. 23 is a schematic diagram of a secondary battery according to a tenth embodiment of the present disclosure;

FIG. 24 is a schematic diagram of a jelly roll and a first thermally conductive member according to an embodiment of the present disclosure;

FIG. 25 is a schematic diagram of a jelly roll and a first thermally conductive member according to another embodiment of the present disclosure;

FIG. 26 is a schematic diagram of a thermally conductive member according to a first embodiment of the present disclosure;

FIG. 27 is a schematic diagram of the thermally conductive member according to a second embodiment of the present disclosure;

FIG. 28 is a schematic diagram of the thermally conductive member according to a third embodiment of the present disclosure;

FIG. 29 is a schematic diagram of the thermally conductive member according to a fourth embodiments of the present disclosure; and

FIG. 30 is a schematic diagram of the thermally conductive member according to a fifth embodiment of the present disclosure.

### REFERENCE SIGNS

1: case;
   11: accommodating cavity;
      111: side wall;
      112: bottom wall;
         112a: first recessed portion;
         112b: first protruding portion;
         112c: second recessed portion;
2: jelly roll;
   21: bending section;
   22: roll structure;
   23: tab;
      231: positive tab;
      232: negative tab;
3: battery pack;
   31: battery module;
   32: heat exchange member;
      321: body portion;
      322: second protruding portion;
      323: third recessed portion;
      324: first limiting portion;
      325: second limiting portion;
      326: first limiting protrusion;
      327: second limiting protrusion;
      328: third protruding portion;
4: heat exchange channel;
   41: first heat exchange channel;
   42: second heat exchange channel;
5: energy storage cabinet;
6: thermally conductive member;
   61: first thermally conductive member;
      612: second thermally conductive portion;
   62: second thermally conductive member;
      621: third thermally conductive portion;
      622: fourth thermally conductive portion;
7: top cover assembly;
   71: electrode terminal.

### DESCRIPTION OF EMBODIMENTS

For better illustrating technical solutions of the present disclosure, embodiments of the present disclosure will be described in detail as follows with reference to the accompanying drawings.

It should be noted that, the described embodiments are merely exemplary embodiments of the present disclosure, which shall not be interpreted as providing limitations to the present disclosure. All other embodiments obtained by those skilled in the art without creative efforts according to the embodiments of the present disclosure are within the scope of the present disclosure.

The terms used in the embodiments of the present disclosure are merely for the purpose of describing particular embodiments but not intended to limit the present disclosure. Unless otherwise noted in the context, the singular form expressions “a”, “an”, “the” and “said” used in the embodiments and appended claims of the present disclosure are also intended to represent plural form expressions thereof.

It should be understood that the term “and/or” used herein is merely an association relationship describing associated objects, indicating that there may be three relationships, for example, A and/or B may indicate that three cases, i.e., A existing individually, A and B existing simultaneously, B existing individually. In addition, the character “/” herein generally indicates that the related objects before and after the character form an “or” relationship.

It should be noted that, the expressions such as “upper”, “lower”, “left”, “right” and the like mentioned in embodiments of the present disclosure are described with reference to the placement status in the accompanying drawings, and should not be construed as limiting embodiments of the present disclosure. In addition, it should also be understood that, in the context, while referring to an element being formed “above” or “below” another element, it is possible that the element is directly formed “above” or “below” the other element, it is also possible that the element is formed “above” or “below” the other element via an intermediate element.

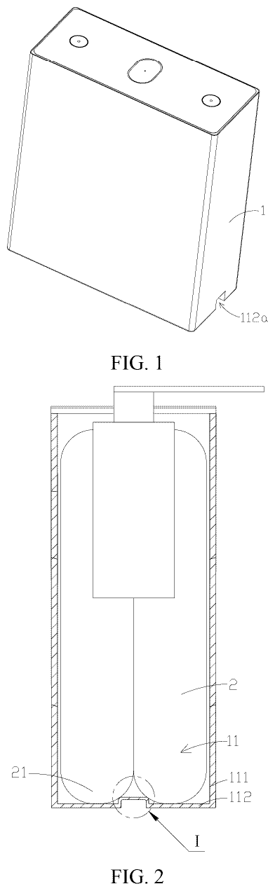

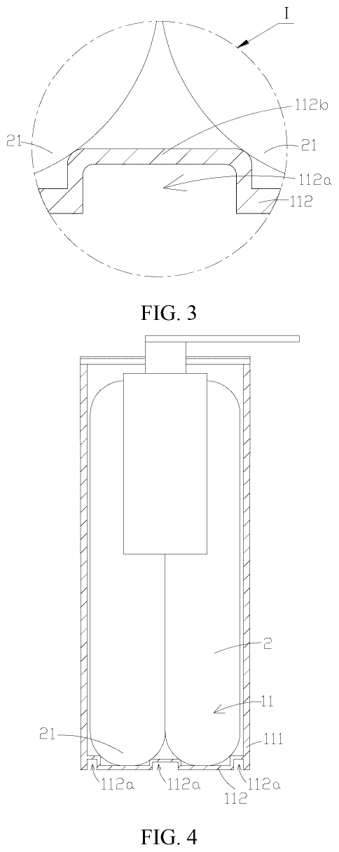

As shown in FIG. 1, some embodiments of the present disclosure provide a secondary battery. As shown in FIG. 2 and FIG. 3, FIG. 2 is a schematic diagram of the secondary battery according to a first embodiment of the present disclosure, and FIG. 3 is a partial enlarged view of Position I shown in FIG. 2. The secondary battery includes a case 1 and at least one jelly roll 2. The case 1 includes a side wall 111 and a bottom wall 112. The side wall 111 and the bottom wall 112 jointly enclose to define an accommodating cavity 11. The accommodating cavity 11 is configured to accommodate components of the secondary battery. Along a height direction of the secondary battery, at least one side of the jelly roll 2 is provided with a bending section 21. Taking a jelly roll as an example, the jelly roll includes a positive electrode plate, a negative electrode plate, and an isolation film located between the positive electrode plate and the negative electrode plate. The isolation film is configured to isolate the positive electrode plate from the negative electrode plate. The negative electrode plate, the isolation film, and the positive electrode plate are sequentially stacked and rolled. The jelly roll may include a planar section and an arc-shaped bending section 21. A projection along an axial direction of the jelly roll may have an approximately runway-shape. That is, two ends of the jelly roll are arc-shaped. An arc-shaped region is the bending section 21, and a section between two ends is a straight section. In the solution provided by the embodiments of the present disclosure, a side of the jelly roll 2 facing the bottom wall 112 of the case 1 is provided with the bending section 21. That is, the side of the jelly roll 2 facing the bottom wall 112 of the case 1 is arc-shaped. The bottom wall 112 of the case 1 is provided with at least one first recessed portion 112a. The first recessed portion 112a is located at a side of the bottom wall 112 facing away from an interior of the secondary battery. That is, the first recessed portion 112a is located at an outer side of the case 1 and is recessed towards the interior of the secondary battery, besides, a first protruding portion 112b is formed at an inner side of the bottom wall 112. Along a width direction of the secondary battery, at least part of the bending section 21 is located at one side of the first protruding portion 112b. In the solution provided by the embodiments of the present disclosure, the jelly roll 2 may be transversely positioned in the accommodating cavity 11. An axial direction of the jelly roll 2 is parallel to a length direction of the secondary battery and perpendicular to the width direction of the secondary battery.

The bottom wall 112 of the case 1 is provided with the first recessed portion 112a and the first protruding portion 112b is formed at an interior of the bottom wall 112, so that the bottom wall 112 fits the bending section 21 of the jelly roll 2, thereby increasing an area of contact between the bottom wall 112 and the jelly roll 2. When a secondary lithium battery is applied to a battery pack 3, a heat exchange member 32 of the battery pack 3 may extend into the first recessed portion 112a to contact the secondary battery. Compared with the bottom wall 112 which is flat, through the arrangement of the first recessed portion 112a at the bottom wall 112 of the case 1, an area of contact between the heat exchange member 32 and the secondary battery can be increased, thereby helping improve efficiency of heat exchange and improving heat dissipation efficiency of the secondary battery, and thus helping improve operational stability and safety of the secondary battery and being more in line with an actual usage requirement.

When the secondary battery is applied to a device such as the battery pack 3, the first recessed portion 112a can cooperate with the heat exchange member 32, so that accuracy of a relative position between the secondary battery and the heat exchange member 32 can be improved, and stability of contact therebetween can be improved, thereby improving the heat dissipation efficiency of the secondary battery. Through the arrangement of the first recessed portion 112a, the area of contact between the secondary battery and the heat exchange member 32 can be increased to improve heat exchange efficiency of the secondary battery. Compared with the secondary battery without the first recessed portion 112a, the heat dissipation efficiency of the secondary battery can be improved by 3% to 5% through the arrangement of the first recessed portion 112a. At the same time, since the first recessed portion 112a is recessed towards the interior of the secondary battery and occupies a certain internal space, an amount of electrolyte can be reduced. Compared with the secondary battery without the first recessed portion 112a, the amount of electrolyte can be reduced by 1% to 2% through the arrangement of the first recessed portion 112a, thereby saving costs. By use of the solution provided by the embodiments of the present disclosure, the heat dissipation efficiency of the secondary battery can be improved, and costs of the secondary battery can be reduced, thereby being more in line with an actual usage requirement.

As shown in FIG. 3, in some embodiments, the secondary battery includes at least two jelly rolls 2, the jelly rolls 2 are sequentially arranged along the width direction of the secondary battery, and at least part of the first protruding portion 112b extends into a space between the bending sections 21 of adjacent jelly rolls 2. The secondary battery may include two, three, four, or more jelly rolls 2.

When the secondary battery includes two or more jelly rolls 2, there may be a gap between the bending sections 21 of adjacent jelly rolls 2, and the first recessed portion 112a may be arranged between adjacent jelly rolls 2, so that the first protruding portion 112b can extend into the gap between adjacent bending sections 21. Through such a design, when the secondary battery cooperates with the heat exchange member 32, the heat exchange member 32 can extend into the first recessed portion 112a, thereby helping increase an area of contact between the heat exchange member 32 and the secondary battery. At the same time, the bottom wall 12 of the case 1 is recessed towards the interior of the secondary battery, so that the bottom wall 12 of the case 1 better fits each jelly roll 2 to increase an area of contact between the bottom wall 12 and the jelly roll 2. When the heat exchange member 32 extends into the first recessed portion 112a, it is conducive to improving the heat transfer efficiency, thereby improving the heat dissipation efficiency and being more in line with an actual usage requirement.

FIG. 4 is a sectional view of the secondary battery according to a second embodiment of the present disclosure. The case 1 is provided with at least three first recessed portions 112a. The first recessed portion 112a is arranged between the bending section 21 and the side wall 111 of the case 1, and/or between adjacent bending sections 21.

For example, the secondary battery includes two jelly rolls 2. The bottom wall 112 may be provided with three first recessed portions 112a, and the first recessed portions 112a are arranged along an arrangement direction of the jelly rolls 2, which is generally the width direction of the secondary battery. One first recessed portion 112a is located between two jelly rolls 2, and the other two first recessed portions 112a are arranged at two ends of the bottom wall 112 along the arrangement direction of the jelly rolls 2. Through such a design, the bending section 21 can be located between adjacent first recessed portions 112a, and two opposite sides of the bending section 21 are each provided with the first recessed portion 112a, so that when the secondary battery cooperates with the heat exchange member 32, the heat exchange member 32 can extend into the respective first recessed portion 112a, thereby helping increase an area of contact between the secondary battery and the heat exchange member 32 to improve the heat exchange efficiency.

When the secondary battery includes n jelly rolls 2, a number of the first recessed portions 112a may be (n+1), and two opposite sides of the bending section 21 of each jelly roll 2 are each provided with the first recessed portion 112a.

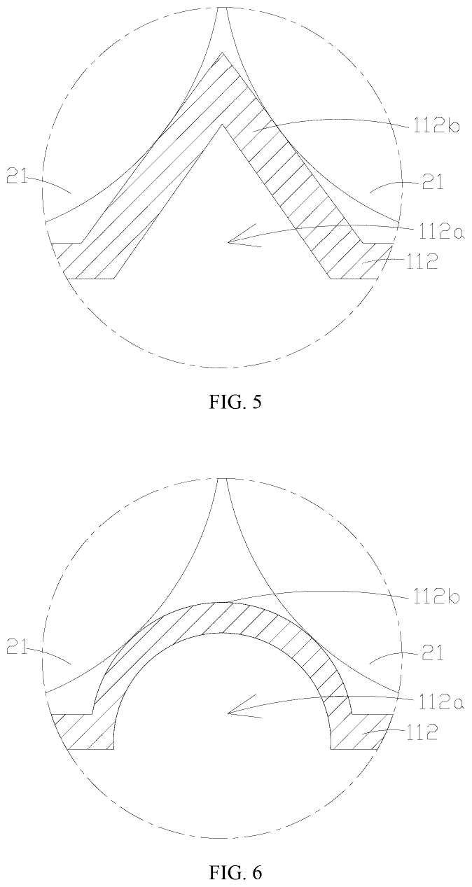

As shown in FIG. 3, FIG. 5, and FIG. 6, FIG. 5 is a partial schematic diagram of a secondary battery according to a third embodiment of the present disclosure, and FIG. 6 is a partial schematic diagram of a secondary battery according to a fourth embodiment of the present disclosure. A cross section of the first recessed portion 112a may have a shape of a rectangle, an arc, a triangle, or the like. When the bottom wall 112 of the case 1 is provided with a plurality of first recessed portions 112a, the plurality of first recessed portions 112a may have a same shape or different shapes. Structures of the first recessed portion 112a and the corresponding first protruding portion 112b may be designed according to a structure of the bending portion of the jelly roll 2.

Through the adjustment of the shape of the first recessed portion 112a, the bottom wall 112 of the case 1 can be better in contact with the jelly roll 2, and the structure of the secondary battery can be more compact, which facilitates the contact between the secondary battery and the heat exchange member 32, thereby improving heat dissipation efficiency of the secondary battery and reducing a possibility of an excessively high temperature of the secondary battery, and thus helping improve operational stability and safety of the secondary battery and being more in line with an actual usage requirement.

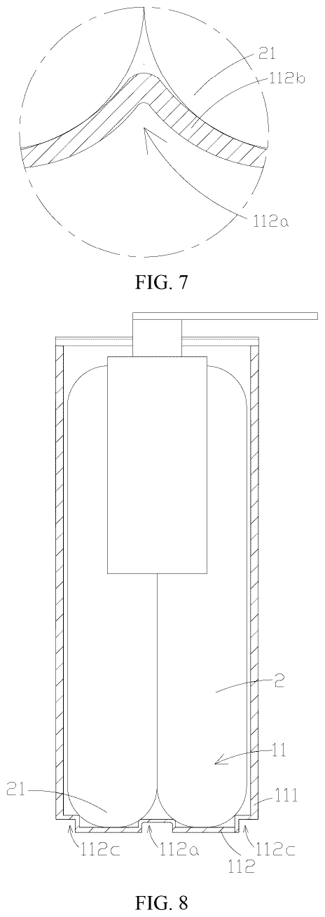

As shown in FIG. 7, FIG. 7 is a partial schematic diagram of a secondary battery according to a fifth embodiment of the present disclosure, at least part of a surface of the first protruding portion 112b fits the bending section 21.

Through such a design, the area of contact between the bottom wall 112 of the case 1 and the jelly roll 2 can be further increased, and the thermal conduction efficiency of contact heat transfer is relatively high. Therefore, by making the first protruding portion 112b fit more the jelly roll 2, the heat dissipation efficiency of the secondary battery can be improved and the space can be saved, so that the secondary battery and the heat exchange member 32 are more compact in structure, which helps reduce an overall volume of the battery pack 3.

In some embodiments, along the height direction of the secondary battery, a depth of the first recessed portion 112a ranges from 2 mm to 30 mm. The depth of the first recessed portion 112a may be 2 mm, 4 mm, 6 mm, 8 mm, 10 mm, 12 mm, 14 mm, 16 mm, 18 mm, 20 mm, 22 mm, 24 mm, 26 mm, 28 mm, 30 mm, or the like.

When the depth of the first recessed portion 112a is less than 2 mm, the depth of the first recessed portion 112a is relatively small. During the cooperation with the heat exchange member 32, a volume of the heat exchange member 32 extending into the first recessed portion 112a is relatively small, and an area of contact with the secondary battery is relatively small, which affects the heat exchange efficiency less. When the depth of the first recessed portion 112a is greater than 30 mm, the depth of the first recessed portion 112a is relatively large, and a protruding height of the first protruding portion 112b in the interior of the secondary battery is relatively large, thereby occupying a relatively large internal space of the secondary battery, which may affect a capacity of the secondary battery, thereby affecting the energy density of the secondary battery. Therefore, the depth of the first recessed portion 112a may be set within a range from 2 mm to 30 mm, which can improve the heat exchange efficiency of the secondary battery and can also reduce an influence of the first recessed portion 112a and the first protruding portion 112b on the capacity of the secondary battery, thereby being more in line with an actual usage requirement.

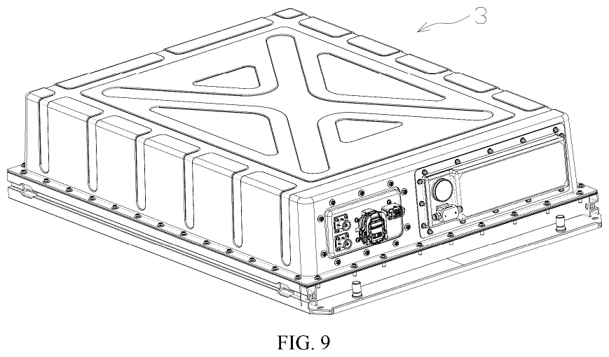

As shown in FIG. 8, FIG. 8 is a partial sectional view of a secondary battery according to a sixth embodiment of the present disclosure, the case 1 is provided with a second recessed portion 112c. Along the width direction of the secondary battery, the second recessed portion 112c is located at two opposite sides of the bottom wall 112. The second recessed portion 112c is recessed along the height direction of the secondary battery, and passes through the side wall 111 of one side of the case 1 along the width direction of the secondary battery. That is, the second recessed portion 112c may be arranged at a connection between the bottom wall 112 and the side wall 111.

Through such a design, an area of the bottom wall 112 can be increased, and when the secondary battery is in cooperation with the heat exchange member 32, an area of contact between the bottom wall 112 and the heat exchange member 32 can be increased, thereby improving the heat dissipation efficiency of the secondary battery and improving operational stability of the secondary battery.

Through the arrangement of the second recessed portion 112c, the area of contact between the secondary battery and the heat exchange member 32 can be further increased, thereby further improving the heat dissipation efficiency of the secondary battery. Moreover, when the secondary battery is applied to a device such as a battery pack, the second recessed portion 112c can further be in cooperation with the second recessed portion 112c of an adjacent secondary battery to jointly be in cooperation with the heat exchange member 32, which can improve the cooperation accuracy between the secondary battery and the heat exchange member 32 and can also improve accuracy of a relative position between adjacent secondary batteries. Compared with the secondary battery without the first recessed portion 112a and the second recessed portion 112c, in the solution provided by the embodiments of the present disclosure, through the arrangement of both the first recessed portion 112a and the second recessed portion 112c, the heat dissipation efficiency of the secondary battery can be improved by 4% to 6%. Moreover, as the number of the recessed portions increases, the amount of the electrolyte can be further reduced generally by 1.5% to 3%, thereby helping save the costs and being more in line with an actual usage requirement.

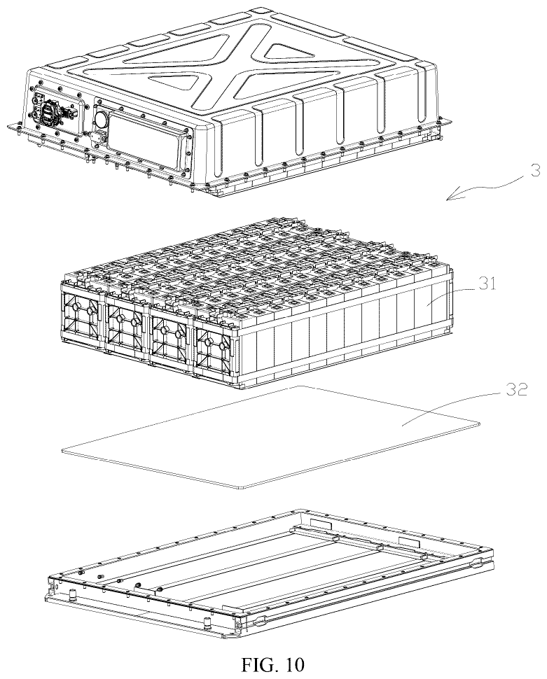

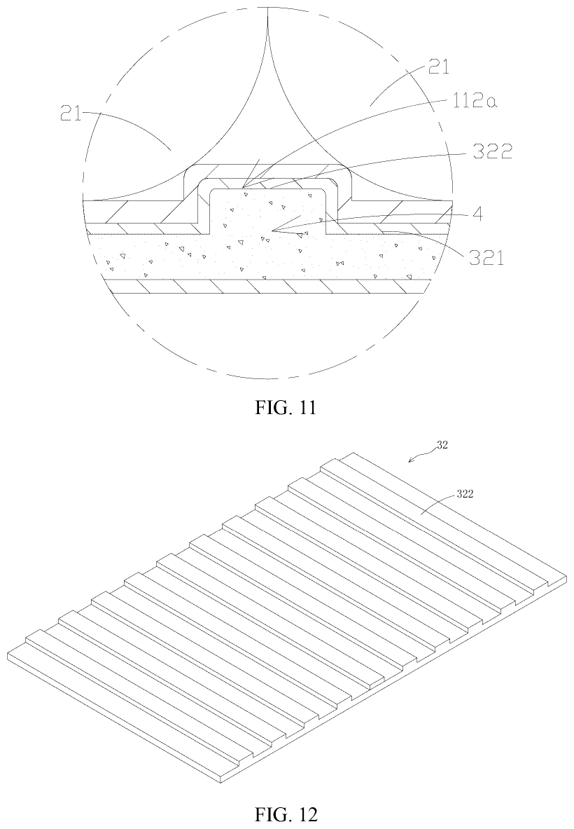

As shown in FIG. 9, based on the secondary battery provided by the above embodiments, some embodiments of the present disclosure further provide a battery pack 3. As shown in FIG. 10, the battery pack 3 includes a battery module 31 and a heat exchange member 32. The battery module 31 includes at least one secondary battery as described in any of the above embodiments. A plurality of secondary batteries may be in series connection, parallel connection, or parallel-series connection to form the battery module 31. The parallel-series connection means that the plurality of secondary batteries are connected in series and in parallel at the same time. In some embodiments, the plurality of secondary batteries may be directly connected in series, or in parallel, or in series and in parallel together, and then the battery module 31 formed by the plurality of secondary batteries is accommodated in a cabinet of the battery pack 3. The plurality of secondary batteries may be arranged side by side along a length direction of the battery pack 3 or may be arranged side by side along a width direction of the battery pack 3. In other embodiments, a plurality of secondary batteries may be first connected in series, or in parallel, or in series and in parallel to form a battery module 31, and then a plurality of battery modules 31 are connected in series, or in parallel, or in series and in parallel to form an entirety which is accommodated in a cabinet of the battery pack 3. Along a height direction of the battery pack 3, as shown in FIG. 11, FIG. 11 is a partial schematic diagram of a battery pack according to some embodiments of the present disclosure, the secondary battery is arranged above the heat exchange member 32. At least part of the heat exchange member 32 is located at one side where the bottom wall 112 of the secondary battery is located. The heat exchange member 32 includes a heat exchange channel 4. At least part of the heat exchange channel 4 is located in the first recessed portion 112a.

The heat exchange channel 4 is located in the first recessed portion 112a of the secondary battery, so that the heat exchange member 32 and the secondary battery are more compact in structure, thereby increasing the area of contact between the heat exchange member 32 and the secondary battery. The heat exchange channel 4 is located in the first recessed portion 112a, so that heat exchange with the secondary battery when a heat exchange medium flows in the heat exchange channel 4 can be facilitated, thereby helping improve efficiency of heat exchange between the heat exchange member 32 and the secondary battery, which can improve heat dissipation efficiency of the battery pack 3, improve operational stability and safety of the battery pack 3, and be more in line with an actual usage requirement.

As shown in FIG. 11 and FIG. 12, FIG. 12 is a schematic diagram of a heat exchange member according to a first embodiment of the present disclosure, the heat exchange member 32 includes a body portion 321 and a second protruding portion 322. The second protruding portion 322 is arranged at a side of the body portion 321 facing the secondary battery, and at least part of the second protruding portion 322 extends into the first recessed portion 112a. At least part of the heat exchange channel 4 of the heat exchange member 32 is arranged in the second protruding portion 322.

The heat exchange channel 4 of the heat exchange member 32 may be simultaneously arranged at the body portion 321 and at the second protruding portion 322. Through the arrangement of the second protruding portion 322 at the body portion 321, the cooperation between the heat exchange member 32 and the secondary battery can be facilitated, so that the heat exchange member 32 and the secondary battery are more compact in structure, which helps increase the area of contact between the heat exchange member 32 and the secondary battery. Through the arrangement of the heat exchange channel 4 at the second protruding portion 322, it is conducive to further increasing an area of a heat exchange region between the heat exchange member 32 and the secondary battery, thereby helping improve heat dissipation efficiency of the battery pack 3. At the same time, the heat exchange member 32 is provided with the second protruding portion 322, then during the mounting, the secondary battery and/or the battery module 31 can be positioned through the cooperation between the second protruding portion 322 and the first recessed portion 112a, thereby improving the mounting accuracy of the secondary battery and/or the battery module 31.

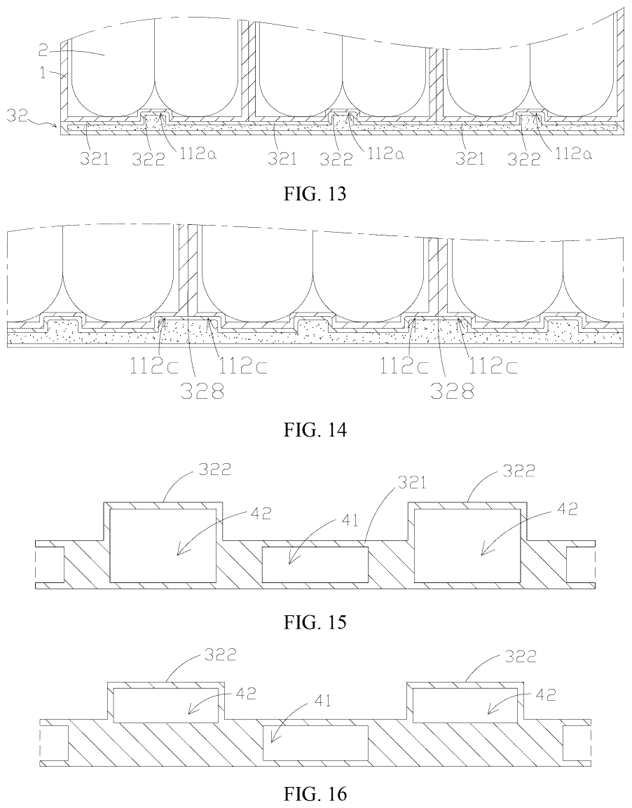

As shown in FIG. 12 and FIG. 13, FIG. 13 is a schematic diagram of a battery pack according to a first embodiment of the present disclosure, along the width direction of the secondary battery, the heat exchange member 32 is provided with a plurality of second protruding portions 322, and each second protruding portion 322 can extend into the corresponding first recessed portion 112a.

A same heat exchange member 32 may be configured to exchange heat for a plurality of secondary batteries. Through the arrangement of the plurality of second protruding portions 322 at the heat exchange member 32, the second protruding portions 322 of the heat exchange member 32 can extend into the first recessed portions 112a of two or more secondary batteries at the same time. Through such a design, a plurality of secondary batteries can use a same heat exchange member 32 for heat exchange at the same time, which helps reduce the number of the heat exchange member 32 and reduce difficulty of assembly. At the same time, the heat exchange member 32 can position a plurality of secondary batteries at the same time, thereby improving accuracy of a relative position between each secondary battery and the battery module 31 and being more in line with an actual usage requirement.

As shown in FIG. 14, FIG. 14 is a partial schematic diagram of a battery pack according to a fourth embodiment of the present disclosure, the secondary battery includes a second recessed portion 112c. The second recessed portions 112c of adjacent secondary batteries are in communication with each other. The heat exchange member 32 is provided with a third protruding portion 328. The third protruding portion 328 extends into the second recessed portion 112c.

Since the second recessed portion 112c of the secondary battery passes through the side wall 111 of the case 1, the second recessed portions 112c of the adjacent secondary batteries may be in communication along width directions of the secondary batteries to form a new recessed portion. Through the arrangement of the third protruding portion 328 at the body portion 321, the body portion 321 can be in better cooperation with the new recessed portion, so that a structure between the secondary battery and the heat exchange member 32 is more compact, thereby helping save the space.

As shown in FIG. 15 and FIG. 16, FIG. 15 is a schematic diagram of a heat exchange member according to a second embodiment of the present disclosure, and FIG. 16 is a schematic diagram of a heat exchange member according to a third embodiment of the present disclosure, the heat exchange member 32 includes a first heat exchange channel 41 and a second heat exchange channel 42. The first heat exchange channel 41 is arranged at the body portion 321. The second heat exchange channel 42 is partially arranged at the body portion 321 and partially arranged at the second protruding portion 322. A cross-sectional area of the second heat exchange channel 42 is no less than a cross-sectional area of the first heat exchange channel 41.

Through a change in the cross-sectional area of the heat exchange channel 4, a flow rate of a heat exchange medium in the heat exchange channel 4 may be adjusted. Compared with other positions of the heat exchange member 32, the position of the heat exchange member 32 provided with the first protruding portion 112b has a relatively large area of contact with the secondary battery. Therefore, the cross-sectional area of the second heat exchange channel 42 may be greater than the cross-sectional area of the first heat exchange channel 41. The flow rate of the heat exchange medium may be reduced by increasing the area of the heat exchange channel 4 arranged at the first protruding portion 112b, so that the heat exchange medium can fully perform heat exchange with the secondary battery, thereby improving utilization of the heat exchange medium and improving the heat dissipation efficiency, thereby being more in line with an actual usage requirement.

In some embodiments, the first heat exchange channel 41 may be in communication with the second heat exchange channel 42, the heat exchange medium may flow in the first heat exchange channel 41 and the second heat exchange channel 42, and adjacent heat exchange channels 4 may be connected end to end, thereby forming an approximately “S” shape.

In some embodiments, the first heat exchange channel 41 may be not in communication with the second heat exchange channel 42. The first heat exchange channel 41 and the second heat exchange channel 42 may use different heat exchange media. The first heat exchange channel 41 and the second heat exchange channel 42 are respectively provided with independent inlet and outlet, to reduce a possibility of mixing between different types of heat exchange media. When the heat exchange member 32 includes a plurality of first heat exchange channels 41 and a plurality of second heat exchange channels 42, the first heat exchange channels 41 may be in communication with each other, and the second heat exchange channels 42 may be in communication with each other. In practical applications, flow rates of the heat exchange media in the first heat exchange channel 41 and the second heat exchange channel 42 may be adjusted according to actual requirements. The heat exchange medium may be a glycol aqueous solution, nitrogen, argon, or the like. The heat exchange media in the first heat exchange channel 41 and in the second heat exchange channel 42 may be different. Since an area of contact between the second heat exchange channel 42 and the secondary battery is larger, the thermal conduction efficiency and the specific heat capacity of the heat exchange medium in the second heat exchange channel 42 may be higher than those of the heat exchange medium in the first heat exchange channel 41. The flow rates of the heat exchange media in the first heat exchange channel 41 and the second heat exchange channel 42 may be respectively configured according to actual requirements. The flow rates may be the same or different. For example, in some embodiments, the flow rate of the heat exchange medium in the second heat exchange channel 42 is less than the flow rate of the heat exchange medium in the first heat exchange channel 41. Since an area of contact between the second heat exchange channel 42 and the secondary battery is larger, by reducing the flow rate of the heat exchange medium in the second heat exchange channel 42, the heat exchange medium can fully exchange heat with the secondary battery, thereby improving utilization and heat exchange efficiency of the heat exchange medium.

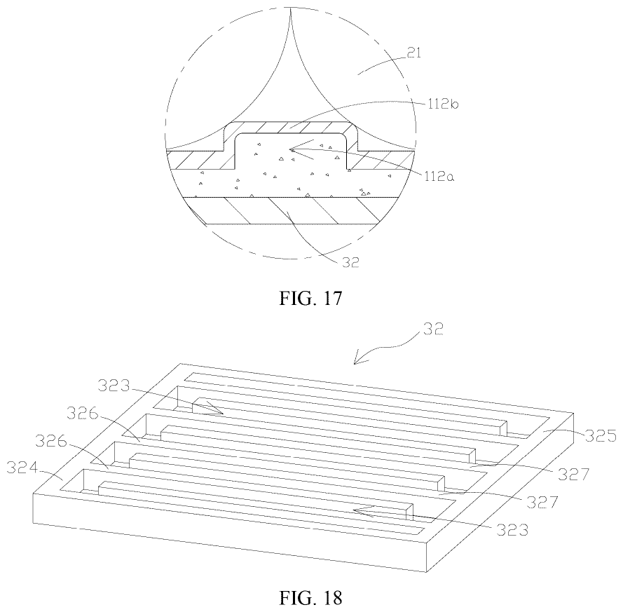

As shown in FIG. 17, FIG. 17 is a partial schematic diagram of a battery pack according to a third embodiment of the present disclosure, the body portion 321 of the heat exchange member 32 may have a tray-type structure. The heat exchange member 32 is in cooperation with the bottom wall 112 of the case 1 of the secondary battery, to jointly enclose to define the heat exchange channel 4.

Through such a design, the bottom wall 112 of the case 1 can be configured to form a wall surface of the heat exchange channel 4, and the heat exchange medium can directly contact the bottom wall 112 of the case 1 of the secondary battery, thereby helping improve heat transfer efficiency.

As shown in FIG. 18, FIG. 18 is a schematic diagram of a heat exchange member according to a fourth embodiment of the present disclosure, a side of the body portion 321 of the heat exchange member 32 facing the secondary battery is provided with a third recessed portion 323, and the third recessed portion 323 and the first recessed portion 112a jointly enclose to define the heat exchange channel 4.

Through such a design, it is conducive to increasing a cross-sectional area of the heat exchange channel 4 to facilitate heat exchange between the heat exchange medium and the secondary battery, thereby helping improve utilization of the heat exchange medium and being more in line with an actual usage requirement.

As shown in FIG. 18, in some embodiments, along the length direction of the secondary battery, two opposite sides of the body portion 321 are respectively provided with a first limiting portion 324 and a second limiting portion 325, and the heat exchange member 32 includes a first limiting protrusion 326 and a second limiting protrusion 327. The first limiting protrusion 326 and the second limiting protrusion 327 protrude along the height direction of the secondary battery. Along the length direction of the secondary battery, the first limiting protrusion 326 is connected to the first limiting portion 324 and is spaced apart from the second limiting portion 325, and the second limiting protrusion 327 is connected to the second limiting portion 325 and is spaced apart from the first limiting portion 324. Along the width direction of the secondary battery, the first limiting protrusions 326 and the second limiting protrusions 327 are staggered, and the third recessed portion 323 is located between the first limiting protrusion 326 and the second limiting protrusion 327 that are adjacent.

Through such a design, the heat exchange channel 4 approximately in an “S” shape can be formed at the heat exchange member 32, which facilitates the flow of the heat exchange medium and helps extend a distance by which the heat exchange medium flows in the heat exchange channel 4, thereby allowing the heat exchange medium to fully perform heat exchange with the secondary battery and being more in line with an actual usage requirement.

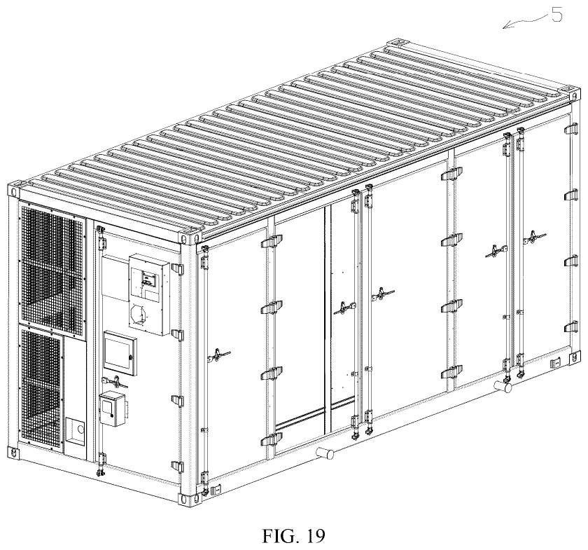

Based on the battery pack 3 provided in the above embodiments, as shown in FIG. 19, some embodiments of the present disclosure further provide an energy storage cabinet 5. The energy storage cabinet 5 includes an inverter, a battery management system, and a battery pack 3. The inverter is configured to convert DC power into AC power. The inverter has advantages of higher conversion efficiency, faster startup, higher safety, and can also have protection functions such as short circuit, overload, overvoltage/undervoltage, and over-temperature. The battery management system is configured to make the battery pack 3 operate within a safe operating condition, and may control charging and discharging power of the battery pack 3 according to factors such as an ambient temperature, a battery state, and an electricity demand, to enhance safety of the battery pack 3 and make an operating state of the battery pack 3 more reasonable, thereby helping prolong a battery life and a service life of the battery pack 3. The battery pack 3 may be the battery pack 3 as described in any one of the above embodiments, so that the battery pack 3 achieves the above technical effects. Therefore, the energy storage cabinet 5 including the battery pack 3 also achieves the corresponding technical effects, which will not be described again herein.

The embodiments of the present disclosure provide a secondary battery, a battery pack 3, and an energy storage cabinet 5. The secondary battery includes a case 1 and at least one jelly roll 2. The jelly roll 2 is arranged in an accommodating cavity 11 of the case 1. Along a height direction of the secondary battery, one side of the jelly roll 2 is provided with a bending section 21, a bottom wall 112 of the case 1 is provided with a first recessed portion 112a recessed towards an interior of the secondary battery, and a first protruding portion 112b is correspondingly formed at an inner side of the bottom wall 112. At least part of the bending section 21 is located at one side of the first protruding portion 112b along a width direction of the secondary battery. Through such a design, an area of contact between the bottom wall 112 and the jelly roll 2 can be increased. At the same time, the first recessed portion 112a can be configured to accommodate a heat exchange member 32 to increase an area of contact between the heat exchange member 32 and the secondary battery, thereby helping improve heat dissipation efficiency of the secondary battery.

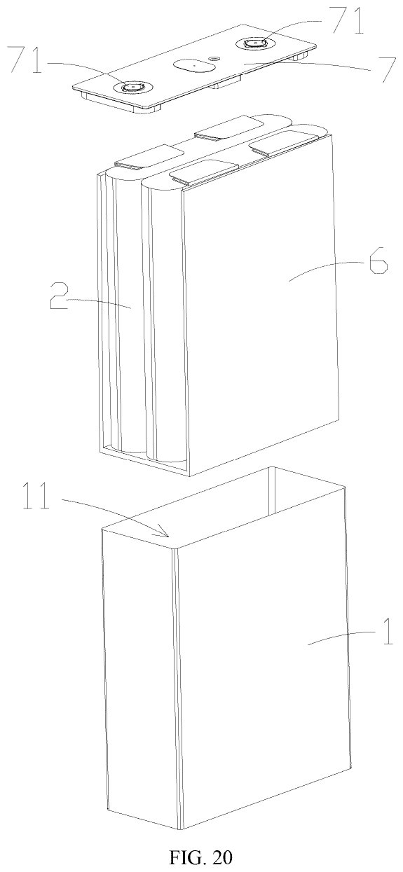

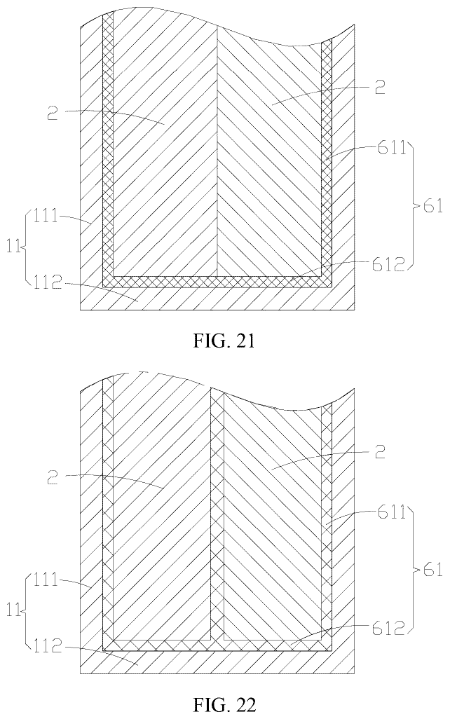

As shown in FIG. 20 and FIG. 21, some embodiments of the present disclosure provide a secondary battery, including a case 1, a thermally conductive member 6, and at least one jelly roll 2. The case 1 includes a side wall 111 and a bottom wall 112, the side wall 111 and the bottom wall 112 are connected and jointly enclose to define an accommodating cavity 11. The jelly roll 2 is arranged in the accommodating cavity 11. The thermally conductive member 6 includes a first thermally conductive member 61, the first thermally conductive member 61 includes a first thermally conductive portion 611 and a second thermally conductive portion 612, and the first thermally conductive portion 611 and the second thermally conductive portion 612 are connected and form an angle. Along a length direction and/or a width direction of the secondary battery, the first thermally conductive portion 611 is located at one side of the jelly roll 2. Along a height direction of the secondary battery, the second thermally conductive portion 612 is located at a side of the jelly roll 2 facing the bottom wall 112.

Through the arrangement of the thermally conductive member 6 to the secondary battery, heat generated by the secondary battery during operation can be transferred, thereby reducing a risk of an influence of a temperature of the secondary battery caused by accumulation of the heat in the secondary battery on normal operation of the secondary battery. Through the arrangement of the thermally conductive member 6, the heat can be transferred from a side face to the bottom of the secondary battery. Generally, an electrode terminal 71 of the secondary battery generates a large amount of heat, and the electrode terminal 71 is typically located at a top of the secondary battery. Therefore, the bottom of the secondary battery generally generates less heat and has a lower temperature. Through the arrangement of the thermally conductive member 6, the heat generated by the secondary battery can be transferred to the bottom of the secondary battery, thereby making an overall temperature of the secondary battery more balanced and helping improve operational stability of the secondary battery.

Generally, a plurality of secondary batteries may be electrically connected to form a battery module 31, and the battery module 31 is applicable to the battery pack 3. The battery pack 3 may include a heat exchange member such as a liquid cooling plate. The heat exchange member is generally located at the bottom of the battery module 31. The bottom of the secondary battery and the bottom of the battery module 31 are located at a same side. Therefore, by transferring the heat generated by the secondary battery to the bottom of the secondary battery, heat exchange between the secondary battery and the heat exchange member can be facilitated, thereby cooling the secondary battery through the heat exchange member and improving the heat exchange efficiency.

The first thermally conductive portion 611 may be located at one side of the jelly roll 2, for example, at one side of the jelly roll 2 along the width direction of the secondary battery, or at one side of the jelly roll 2 along the length direction of the secondary battery, or the first thermally conductive portion 611 may be arranged along each of the width direction and the length direction of the secondary battery, which may be arranged according to a heating condition of the jelly roll 2. In some embodiments, the first thermally conductive member 61 may include a first thermally conductive portion 611 and a second thermally conductive portion 612. That is, the first thermally conductive member 61 may have an “L” shape.

Through the arrangement of the first thermally conductive portion 611 at at least one side of the jelly roll 2, the heat dissipation efficiency of the secondary battery can be improved. When the first thermally conductive portion 611 is located at one side of the jelly roll 2 along the width direction of the secondary battery, the heat dissipation efficiency of the secondary battery can be improved by 2% to 4%. When the first thermally conductive portion 611 is located at one side of the secondary battery along the length direction of the secondary battery, the heat dissipation efficiency of the secondary battery can be improved by 3% to 5%. When the secondary battery pack 3 includes a plurality of jelly rolls 2 and the first thermally conductive portion 611 is arranged between adjacent jelly rolls 2, the heat dissipation efficiency of the secondary battery can be improved by 3% to 6%.

In some embodiments, an area of one side of the jelly roll 2 is a along the width direction of the secondary battery, and an area of one side of the secondary battery is b along the length direction of the secondary battery, where a>b. The first thermally conductive portion 611 is located at one side of the jelly roll 2 along the width direction of the secondary battery.

Through such a design, the first thermally conductive portion 611 can be located at a side of the jelly roll 2 with a larger area. Therefore, an area of contact between the first thermally conductive portion 611 and the jelly roll 2 can be increased, and thermal conduction efficiency can be improved, so that the first thermally conductive member 61 can transfer heat to the bottom of the secondary battery faster.

In some embodiments, the first thermally conductive portion 611 may cover an entire surface at one side of the jelly roll 2 along the width direction of the secondary battery.

When the jelly roll 2 is a jelly roll, surfaces at two sides of the jelly roll 2 are planar surfaces along the width direction of the secondary battery, and the surfaces at two sides of the jelly roll 2 are arc-shaped surfaces along the length direction of the secondary battery. Compared with the planar surface, the arc-shaped surface has a smaller size, and it is more difficult for the first thermally conductive member 61 to fit the arc-shaped surface. Therefore, through the arrangement of the second thermally conductive portion 612 at one side of the planar surface of the jelly roll 2, forming difficulty of the first thermally conductive member 61 can be reduced, and it is conducive to improving the thermal conduction efficiency.

In some embodiments, the first thermally conductive portion 611 is located at one side of the jelly roll 2 along the length direction of the secondary battery.

According to actual measurements, compared with a planar position of the jelly roll 2, an arc-shaped section of the jelly roll 2 generates a larger amount of heat. Through the arrangement of the first thermally conductive portion 611 at one side of the jelly roll 2 along the length direction of the secondary battery, the first thermally conductive portion 611 can be arranged at one side where the arc-shaped surface of the jelly roll 2 is located, so that the heat can be dissipated at a region where the jelly roll 2 generates a larger amount of heat, thereby reducing a possibility of an excessively high local temperature of the secondary battery caused by accumulation of the heat.

In some embodiments, the secondary battery may include at least two jelly rolls 2. Two, three, four, or more jelly rolls 2 may be provided. When the secondary battery pack 3 includes a plurality of jelly rolls 2, the first thermally conductive portion 611 may be arranged between adjacent jelly rolls 2.

According to actual measurements, when the secondary battery pack 3 includes a plurality of jelly rolls 2, a larger amount of heat is generated between adjacent jelly rolls 2. Through the arrangement of the first thermally conductive portion 611 between adjacent jelly rolls 2, heat can be transferred to the bottom of the secondary battery in time, thereby reducing a possibility of accumulation of heat between adjacent jelly rolls 2, thereby making the temperature of the secondary battery more balanced, improving operational stability and safety of the secondary battery, and thus being more in line with an actual usage requirement.

As shown in FIG. 21, in some embodiments, the first thermally conductive member 61 includes at least two first thermally conductive portions 611. The first thermally conductive portions 611 are arranged in sequence along the width direction of the secondary battery, and the jelly roll 2 is located between adjacent first thermally conductive portions 611.

Through such a design, two opposite sides of the jelly roll 2 can each be provided with the first thermally conductive portion 611, so that an area of contact between the first thermally conductive member 61 and the jelly roll 2 can be increased, which helps improve thermal conduction efficiency of the first thermally conductive member 61, facilitates heat dissipation of the secondary battery, reduces a possibility of an influence of an excessively high local temperature of the secondary battery on normal operation of the secondary battery, thereby improving safety of the secondary battery.

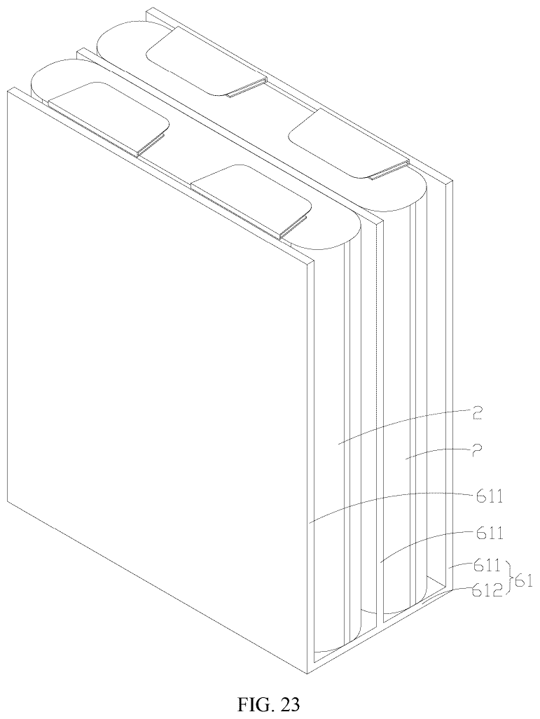

As shown in FIG. 22 and FIG. 23, in some embodiments, the first thermally conductive member 61 includes at least three first thermally conductive portions 611, and the secondary battery pack 3 includes at least two jelly rolls 2. The jelly rolls 2 are sequentially arranged along the width direction of the secondary battery. Two opposite sides of each jelly roll 2 are each provided with the first thermally conductive portion 611, and sides of adjacent jelly rolls 2 close to each other may share a same first thermally conductive portion 611.

Through the arrangement of the first thermally conductive portion 611 between adjacent jelly rolls 2, an overall area of contact between the first thermally conductive member 61 and the jelly roll 2 can be further increased, thereby improving thermal conduction efficiency between the first thermally conductive member 61 and the jelly roll 2, improving the heat dissipation capability, and helping improve operational stability of the secondary battery.

Through such a design, the first thermally conductive member 61 can better cover the jelly roll 2, so that two opposite sides of the jelly roll 2 are each provided with the first thermally conductive portion 611. Moreover, due to a relatively large amount of heat generated between adjacent jelly rolls 2, heat between adjacent jelly rolls 2 can be dissipated more quickly by increasing the number of the first thermally conductive portions 611, so that the heat dissipation efficiency of the secondary battery can be improved.

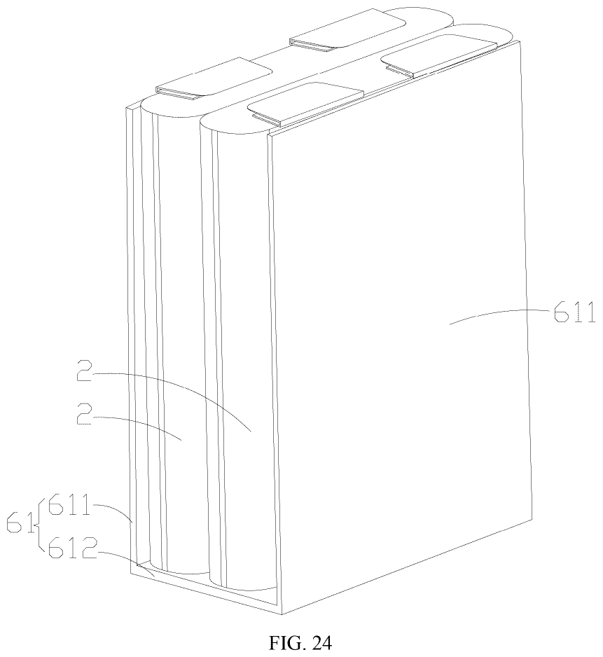

As shown in FIG. 21, FIG. 22, and FIG. 24, in some embodiments, the secondary battery 3 includes at least two jelly rolls 2. The jelly rolls 2 are sequentially arranged along the width direction of the secondary battery. Along the height direction of the secondary battery, a projections of each jelly roll 2 is located within a projection range of a same second thermally conductive portion 612.

Through such a design, a plurality of jelly rolls 2 can share a same second thermally conductive portion 612 for heat transfer, thereby improving utilization of the second thermally conductive portion 612. The first thermally conductive member 61 may have a “U” shape, or a shape of “E” rotated ninety degrees, or the like, and fit a surface of the jelly roll 2. When the bottom shares a same second thermally conductive portion 612, the number of the first thermally conductive member(s) 61 may be reduced. When assembling the secondary battery, only one first thermally conductive member 61 is provided therein. It is conducive to reducing the costs and processing difficulty and improving production efficiency.

In some embodiments of the present disclosure, a thermally conductive member 6 may replace a Mylar film in the secondary battery. Generally, the Mylar film covers an outer side of the jelly roll 2 to reduce a risk of scratch of the jelly roll 2 when placing it into the case 1. At the same time, the Mylar film can also have an effect of insulation, thereby improving safety of the secondary battery. In the solution provided by the embodiments of the present disclosure, the thermally conductive member 6 is arranged at an outer side of the jelly roll 2, so that the jelly roll 2 can be covered by the thermally conductive member 6, thereby replacing the Mylar film. The thermally conductive member 6 protects and insulates the jelly roll 2 and can also improve heat dissipation efficiency of the secondary battery. Therefore, operational stability of the secondary battery can be improved, which is more in line with an actual usage requirement.

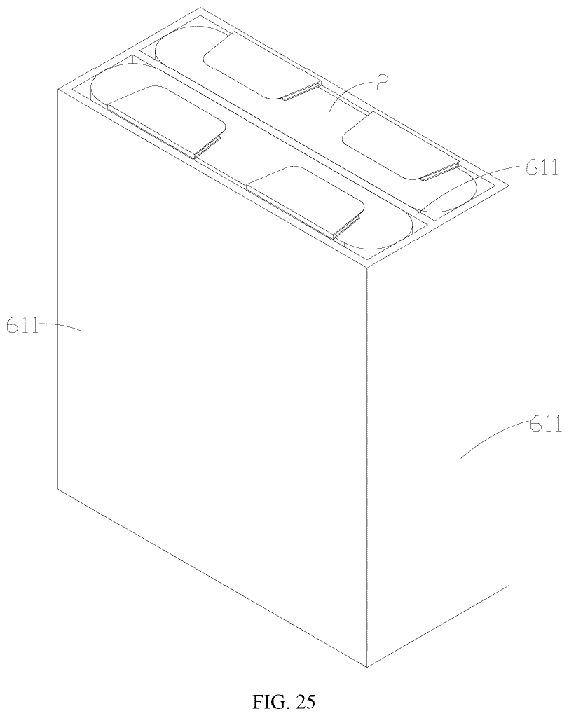

As shown in FIG. 25, in some embodiments, the first thermally conductive member 61 may include a plurality of first thermally conductive portions 611, and two opposite sides of the jelly roll 2 are each provided with the first thermally conductive portion 611 along the length direction and the width direction of the secondary battery.

Through such a design, a coating effect of the thermally conductive member 6 on the jelly roll 2 can be improved, and the heat can be conducted better. Compared with a case that no thermally conductive member 6 is arranged inside the secondary battery, according to the solution shown in FIG. 25, the heat dissipation efficiency of the secondary battery can be improved by 3% to 7%, thereby helping reduce a risk of an excessively high temperature of the jelly roll 2 during the operation of the secondary battery, and thus helping improve operational stability and safety of the secondary battery.

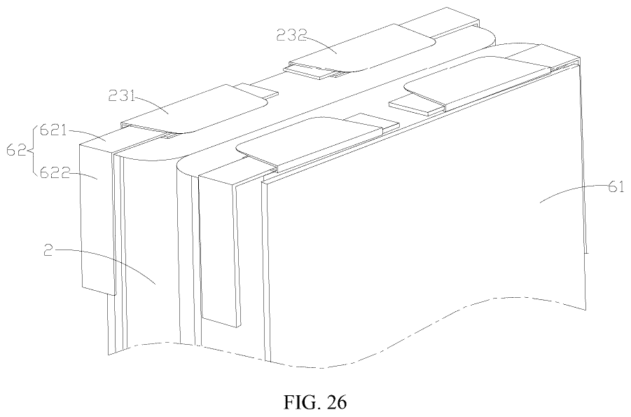

As shown in FIG. 26, in some embodiments, the thermally conductive member 6 includes at least one second thermally conductive member 62. The second thermally conductive member 62 includes a third thermally conductive portion 621 and a fourth thermally conductive portion 622 connected to each other. The third thermally conductive portion 621 and the fourth thermally conductive portion 622 form an angle. The jelly roll 2 includes a roll structure 22 and a tab 23 connected to each other. The roll structure 22 may be formed by rolling of a positive electrode plate, a negative electrode plate, and an isolation film. Chemical energy is converted into electricity through chemical reactions. The tab 23 is configured to be electrically connected to an electrode terminal 71 of a top cover assembly 7 of the secondary battery. The third thermally conductive portion 621 is connected to the tab 23 and is located between the tab 23 and the roll structure 22, and the fourth thermally conductive portion 622 is located between the jelly roll 2 and an inner wall of the case 1.

Generally, compared with other positions, the electrode terminal 71 and the tab 23 of the secondary battery generate larger amounts of heat, and are prone to overheating. Through the arrangement of the second thermally conductive member 62 connected to the tab 23, the heat generated at the tab 23 can be conducted in time, so that heat is kept away from the vicinity of the tab 23 and the electrode terminal 71, thereby helping alleviate heating at positions where the tab 23 and the electrode terminal 71 are located. The third thermally conductive portion 621 is located between the tab 23 and the roll structure 22. That is, the third thermally conductive portion 621 is located at a side of the tab 23 away from the electrode terminal 71. The third thermally conductive portion is connected to a side of the tab 23 away from the electrode terminal 71, thereby having an effect of thermal conduction and reducing an influence of the second thermally conductive member 62 on connection between the tab 23 and the electrode terminal 71.

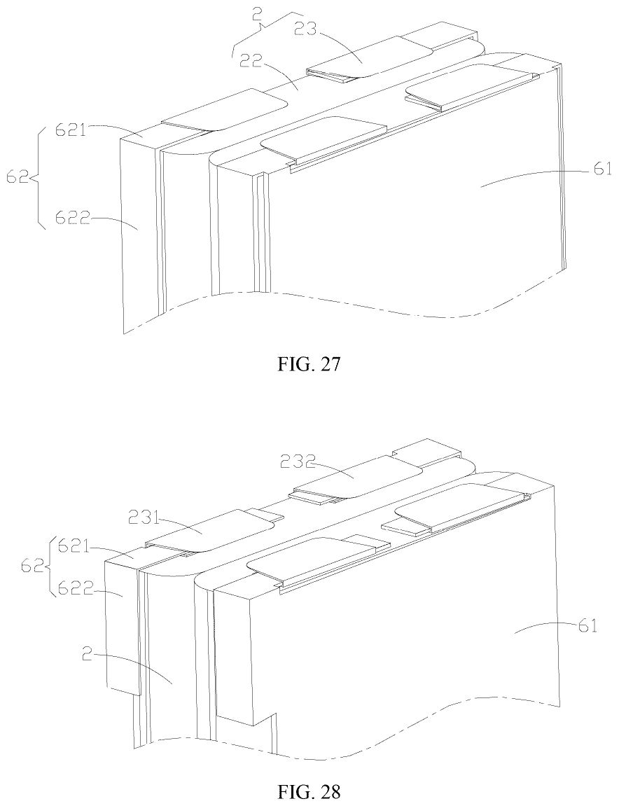

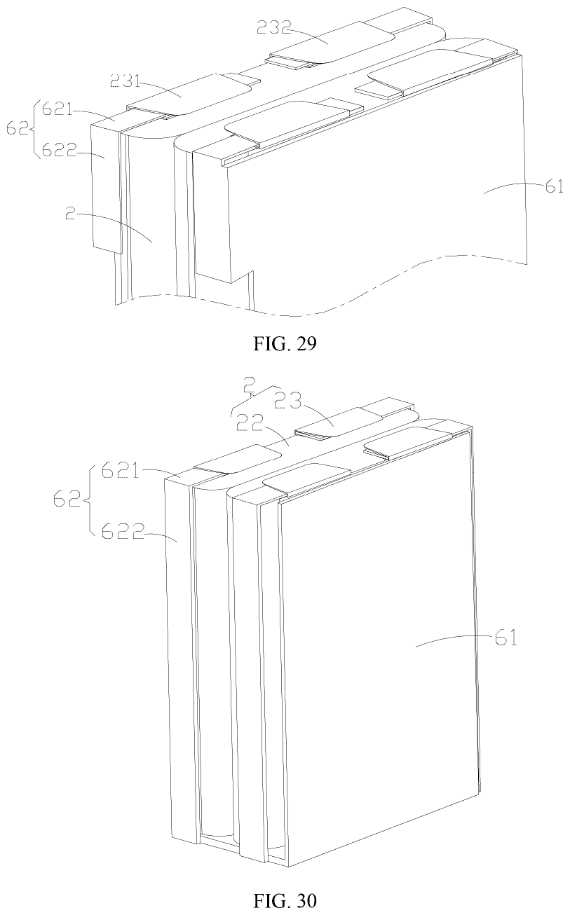

As shown in FIG. 27, FIG. 28, FIG. 29, and FIG. 30, in some embodiments, the third thermally conductive portion 621 may be connected to the first thermally conductive portion 611, and/or the third thermally conductive portion 621 may be connected to at least one of the first thermally conductive portion 611 and the second thermally conductive portion 612. That is, the third thermally conductive portion 621 may be connected to the first thermally conductive portion 611, or may be connected to the second thermally conductive portion 612, or may be connected to both the first thermally conductive portion 611 and the second thermally conductive portion 612.

Through such a design, the first thermally conductive member 61 and the second thermally conductive member 62 can form an integral structure, which helps increase an area of the thermally conductive member 6, so that an area of contact between the thermally conductive member 6 and the jelly roll 2 can be increased, thereby being conducive to improving the thermal conduction efficiency and a thermal conduction effect of the thermally conductive member 6.

As shown in FIG. 30, in some embodiments, a fourth thermally conductive portion 622 may extend to the bottom of the secondary battery and be connected to the second thermally conductive portion 612.

Through such a design, heat generated at the positions of the tab 23 and the electrode terminal 71 can be transferred, through the second thermally conductive member 62, to the second thermally conductive portion 612 at the bottom of the secondary battery, so that energy exchange between the heat exchange member of the battery pack 3 and the secondary battery can be facilitated, and thermal conduction efficiency can be improved, thereby helping improve safety of the secondary battery and being in more line with an actual usage requirement.

As shown in FIG. 30, in some embodiments, the first thermally conductive portion 611 and the second thermally conductive portion 612 may be located at different sides of the jelly roll 2.

Through such a design, heat can be conducted in different directions, thereby helping reduce occurrence of an excessively high local temperature of the secondary battery.

As shown in FIG. 26, in some embodiments, the thermally conductive member 6 includes at least two second thermally conductive members 62. Each jelly roll 2 includes a positive tab 231 and a negative tab 232, and the positive tab 231 and the negative tab 232 are each connected to the corresponding second thermally conductive member 62. Two second thermally conductive members 62 may serve as a positive second thermally conductive member 62 and a negative second thermally conductive member 62, respectively. Through such a design, thermal conduction can be performed on the positive tab 231 and the negative tab 232 respectively. Moreover, in some embodiments, two second thermally conductive members 62 are not directly connected. That is, one second thermally conductive member 62 is not in direct contact with the third thermally conductive portion 621 and the fourth thermally conductive portion 622 of the other second thermally conductive member 62. Through such a design, a possibility of a short circuit caused by an electrical connection between the positive tab 231 and the negative tab 232 through the second thermally conductive member 62 can be reduced, thereby helping improve safety of the secondary battery.

In some embodiments, a thickness of the first thermally conductive portion 611 ranges from 0.1 mm to 4 mm, a thickness of the second thermally conductive portion 612 may range from 0.1 mm to 4 mm, a thickness of the third thermally conductive portion 621 may range from 0.05 mm to 2 mm, and a thickness of the fourth thermally conductive portion 622 may range from 0.1 mm to 4 mm.

The thickness of each of the first thermally conductive portion 611, the second thermally conductive portion 612, and the third thermally conductive portion 621 may be 0.1 mm, 0.4 mm, 0.7 mm, 1.0 mm, 1.3 mm, 1.6 mm, 1.9 mm, 2.2 mm, 2.5 mm, 2.8 mm, 3.1 mm, 3.4 mm, 3.7 mm, 4.0 mm, or the like. The thickness of the third thermally conductive portion 621 may be 0.05 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, or the like. The thicknesses of the first thermally conductive portion 611, the second thermally conductive portion 612, and the fourth thermally conductive portion 622 may be the same or different. The thickness of each of the first thermally conductive portion 611, the second thermally conductive portion 612, the third thermally conductive portion 621, and the fourth thermally conductive portion 622 can be designed according to an internal space of the secondary battery, so as to improve heat dissipation efficiency of the secondary battery and reduce an influence of the thermally conductive member 6 on the capacity of the secondary battery.

In some embodiments, the thermally conductive member 6 includes a thermally conductive layer. The thermally conductive member 6 may have a single-layer structure or a multi-layer structure. One, two, three, four, five, or more thermally conductive layers may be provided. In a case that at least two thermally conductive layers are provided, the at least two thermally conductive layers may be stacked along a thickness direction of the thermally conductive member 6.

In this way, the thermally conductive member 6 may be configured with different thicknesses according to the internal space of the secondary battery, so that a thermal conduction effect of the thermally conductive member 6 can be improved and occupation of the internal space of the secondary battery can be reduced, thereby helping make the structure of the secondary battery more compact and reduce an influence on the capacity of the secondary battery.

In some embodiments, the thermally conductive layer may be a graphite layer, a copper layer, an aluminum layer, or the like, and/or the thermally conductive layer may be a capillary layer. The thermally conductive layer may be formed by a material with high thermal conduction efficiency such as graphite, copper, or aluminum, or may have a capillary structure, to transfer heat. It is more convenient to manufacture the graphite layer, the copper layer, and the aluminum layer. The capillary layer can take away heat by adding a heat exchange medium and using a phase change of the heat exchange medium and have higher heat dissipation efficiency.

In a case that the thermally conductive member 6 includes a plurality of thermally conductive layers, the plurality of thermally conductive layers may be formed by a same material or different materials. Inner and outer layers may be formed by different materials, so that the thermally conductive member 6 has an effect of insulation and also has higher thermal conduction efficiency.

The capillary layer uses the phase change of the heat exchange medium to dissipate heat, which facilitates conversion of the heat exchange medium between liquid and gas for heat dissipation and circulates the heat exchange medium. The capillary layer can dissipate heat evenly around. When a local temperature of the jelly roll 2 is excessively high, the heat exchange medium at this region of the capillary layer corresponding to the position may absorb heat and quickly perform evaporation, and the heat exchange medium at other positions can flow to this region for heat dissipation, thereby helping reduce a possibility of occurrence of an excessively high local temperature of the jelly roll 2. A metal layer has higher thermal conductivity. Taking the copper layer as an example, thermal conductivity of copper is approximately 386 W/m·K to 401 W/m·K. Due to good thermal conductivity, copper can quickly absorb and transfer heat generated by the jelly roll 2.

In some embodiments, the thermally conductive member 6 may have a multi-layer structure, the thermally conductive layer at a middle may be formed by a material with high thermal conductivity such as copper or aluminum, and a thermally conductive layer formed by an insulating material may be arranged at an outer side of the thermally conductive layer formed by the copper or aluminum, so that the thermally conductive member 6 has better thermal conductivity and can also have an effect of insulation, thereby reducing a possibility of a short circuit inside the secondary battery due to the arrangement of the thermally conductive member 6 inside the secondary battery, and thus helping improve safety of the secondary battery.

Based on the secondary battery as described in the above embodiments, as shown in FIG. 9, some embodiments of the present disclosure further provide a battery pack 3. As shown in FIG. 10, the battery pack 3 includes at least one battery module 31. The battery module 31 includes at least one secondary battery as described in any of the above embodiments. When the battery module 31 includes a plurality of secondary batteries, the plurality of secondary batteries may be electrically connected through a busbar. The busbar may be electrically connected to the electrode terminal 71 of the secondary battery by welding or the like. Since the secondary battery achieves the above technical effects, the battery pack 3 including the secondary battery also achieves the corresponding technical effects, which are not described in detail herein.

Generally, the battery pack 3 further includes a heat exchange member. Along the height direction of the battery pack 3, the secondary battery is located above the heat exchange member. In the solution provided by the embodiments of the present disclosure, the thermally conductive member 6 is integrated inside the secondary battery, thereby facilitating transfer of heat generated by the secondary battery during operation to the bottom of the secondary battery, and thus facilitating heat exchange between the heat exchange member and the secondary battery. The heat of the secondary battery is transferred to the bottom of the secondary battery, thereby improving thermal conduction efficiency between the secondary battery and the heat exchange member, and thus helping improve heat dissipation efficiency of the battery pack 3 and reducing a possibility of occurrence of an excessively high temperature of the secondary battery during the operation of the battery pack 3. In this way, the operational stability can be improved and safety of the secondary battery can be improved.

Generally, the heat exchange member is arranged at the bottom of the battery pack 3, and the electrode terminal 71 is located at a side of the secondary battery away from the bottom of the battery pack 3. During operation of the secondary battery, a larger amount of heat is generated at a position adjacent to the electrode terminal 71. If the heat exchange member is arranged only at the bottom of the battery pack 3, heat generated by the electrode terminal 71 cannot be dissipated in time, which easily leads to a rise in temperature of the electrode terminal 71 of the secondary battery and surroundings thereof, thereby leading to an excessively high local temperature of the secondary battery and affecting safety of the battery pack 3. In the embodiments of the present disclosure, through the arrangement of the first thermally conductive member 61 and the second thermally conductive member 62, heat generated by the secondary battery can be transferred in time to the bottom, i.e., transferred along a direction getting close to the heat exchange member, and the second thermally conductive member 62 may be configured to transfer heat generated by the electrode terminal 71 and the tab 23 to a direction getting close to the heat exchange member, thereby reducing occurrence of an excessively high local temperature of the secondary battery and helping improve safety of the battery pack 3.

As shown in FIG. 19, some embodiments of the present disclosure further provide an energy storage cabinet 5. The energy storage cabinet 5 includes an inverter, a battery management system, and at least one battery pack 3. The inverter is configured to convert DC power into AC power. At the same time, the inverter has advantages of higher conversion efficiency, faster startup, higher safety, and can also have protection functions such as short circuit, overload, overvoltage/undervoltage, and over-temperature. The battery management system is configured to make the battery pack 3 operate within a safe operating condition, and may control charging and discharging power of the battery pack 3 according to factors such as an ambient temperature, a battery state, and an electricity demand, to improve safety of the battery pack 3 and make an operating state of the battery pack 3 more reasonable, thereby helping prolong a battery life and a service life of the battery pack 3.

Some embodiments of the present disclosure provide a secondary battery, a battery pack 3, and an energy storage cabinet 5. The secondary battery pack 3 includes a case 1, a thermally conductive member 6, and at least one jelly roll 2. The jelly roll 2 is arranged in an accommodating cavity 11 of the case 1. A first thermally conductive member 61 includes a first thermally conductive portion 611 and a second thermally conductive portion 612 connected to each other. Along a length direction and/or a width direction of the secondary battery, the first thermally conductive portion 611 is located at one side of the jelly roll 2. Along a height direction of the secondary battery, the second thermally conductive portion 612 is located at a side of the jelly roll 2 facing a bottom wall 112 of the case 1. Through such a design, thermal conduction efficiency can be improved, which facilitates heat dissipation of the secondary battery, thereby reducing occurrence of an excessively high local temperature of the secondary battery and helping improve operational stability and safety of the secondary battery.

The above-described embodiments are merely preferred embodiments of the present disclosure and are not intended to limit the present disclosure. Various changes and modifications can be made to the present disclosure by those skilled in the art. Any modifications, equivalent substitutions and improvements made within the principle of the present disclosure shall fall into the protection scope of the present disclosure.

What is claimed is:

1. A secondary battery, comprising:
a case, comprising a side wall and a bottom wall that jointly enclose and define an accommodating cavity; and
at least one jelly roll arranged in the accommodating cavity,
wherein, along a height direction of the secondary battery, at least one side of one of the at least one jelly roll is provided with a bending section, at least one first recessed portion is formed at a side of the bottom wall of the case facing away from an interior of the secondary battery, the at least one first recessed portion is recessed towards the interior of the secondary battery, a first protruding portion is formed at a side of the bottom wall facing the interior of the secondary battery, and at least part of the bending section is located at a side of the first protruding portion along a width direction of the secondary battery.

2. The secondary battery according to claim 1, wherein the at least one jelly roll comprises at least two jelly rolls sequentially arranged along the width direction of the secondary battery, and at least part of the first protruding portion extends between bending sections of adjacent jelly rolls of the at least two jelly rolls.

3. The secondary battery according to claim 2, wherein the at least one first recessed portion comprises at least three first recessed portions, one of which is located between the bending section and the side wall of the case, and/or one of the at least three first recessed portions is located between adjacent bending sections.

4. The secondary battery according to claim 1, wherein a cross section of the at least one first recessed portion has a shape comprising at least one of a rectangle, an arc, or a triangle.

5. The secondary battery according to claim 1, wherein at least part of a surface of the first protruding portion fits the bending section.

6. The secondary battery according to claim 1, wherein along the height direction of the secondary battery, a depth of the at least one first recessed portion ranges from 2 mm to 30 mm.

7. The secondary battery according to claim 1, wherein the case is provided with a second recessed portion, the second recessed portion is recessed along the height direction of the secondary battery, and the second recessed portion is located at each of two opposite sides of the bottom wall along the width direction of the secondary battery and passes through the side wall at a side of the case along the width direction of the secondary battery.

8. The secondary battery according to claim 1, further comprising a thermally conductive member,
wherein the thermally conductive member comprises a first thermally conductive member located between the at least one jelly roll and an inner wall of the case,
wherein the first thermally conductive member comprises a first thermally conductive portion and a second thermally conductive portion connected to each other,
wherein, along a length direction of the secondary battery and/or the width direction of the secondary battery, the first thermally conductive portion is located at a side of the at least one jelly roll, and
wherein, along the height direction of the secondary battery, the second thermally conductive portion is located at a side of the at least one jelly roll facing the bottom wall of the case.

9. The secondary battery according to claim 8, wherein an area, a, of a side of the at least one jelly roll is along the width direction of the secondary battery, wherein an area, b, of a side of the at least one jelly roll is along the length direction of the secondary battery,
wherein a>b, and
wherein the first thermally conductive portion is located at a side of the at least one jelly roll along the width direction of the secondary battery.

10. The secondary battery according to claim 8, wherein the first thermally conductive member comprises at least two first thermally conductive portions sequentially arranged along the width direction of the secondary battery, and the at least one jelly roll is located between adjacent first thermally conductive portions of the at least two first thermally conductive portions.

11. The secondary battery according to claim 10, wherein the first thermally conductive member comprises at least three first thermally conductive portions, and the at least one jelly roll comprises at least two jelly rolls, and
wherein, along an arrangement direction of the at least two jelly rolls, two opposite sides of each of the at least two jelly rolls are each provided with the first thermally conductive portion.

12. The secondary battery according to claim 8, wherein the at least one jelly roll comprises at least two jelly rolls sequentially arranged along the width direction of the secondary battery, and
wherein along the height direction of the secondary battery, projections of the at least two jelly rolls are located within a projection range of a same second thermally conductive portion.

13. The secondary battery according to claim 8, wherein the thermally conductive member comprises at least one second thermally conductive member comprising a third thermally conductive portion and a fourth thermally conductive portion connected to each other, the third thermally conductive portion and the fourth thermally conductive portion forming at an angle, wherein the at least one jelly roll comprises a roll structure and a tab connected to each other,
wherein the third thermally conductive portion is connected to the tab,
wherein the third thermally conductive portion is located between the tab and the roll structure, and
wherein the fourth thermally conductive portion is located between the at least one jelly roll and the inner wall of the case.

14. The secondary battery according to claim 13, wherein the third thermally conductive portion is connected to the first thermally conductive portion, and/or the third thermally conductive portion is connected to at least one of the first thermally conductive portion and the second thermally conductive portion.

15. The secondary battery according to claim 13, wherein the thermally conductive member comprises at least two second thermally conductive members, and the at least one jelly roll comprises a positive tab and a negative tab respectively connected to a corresponding second thermally conductive member.

16. The secondary battery according to claim 13, wherein a thickness of the first thermally conductive portion ranges from 0.1 mm to 4 mm, a thickness of the second thermally conductive portion ranges from 0.1 mm to 4 mm, a thickness of the third thermally conductive portion ranges from 0.05 mm to 2 mm, and a thickness of the fourth thermally conductive portion ranges from 0.1 mm to 4 mm.

17. A battery pack comprising a battery module and a heat exchange member, the battery module comprising at least one secondary battery,
wherein the at least one secondary battery comprises:
a case comprising a side wall and a bottom wall that jointly enclose and define an accommodating cavity; and
at least one jelly roll arranged in the accommodating cavity,
wherein, along a height direction of the at least one secondary battery, at least one side of one of the at least one jelly roll is provided with a bending section, at least one first recessed portion is formed at a side of the bottom wall of the case facing away from an interior of the at least one secondary battery, the at least one first recessed portion is recessed towards the interior of the at least one secondary battery, a first protruding portion is formed at a side of the bottom wall facing the interior of the at least one secondary battery, and at least part of the bending section is located at a side of the first protruding portion along a width direction of the at least one secondary battery,
wherein at least part of the heat exchange member is arranged at a side where the bottom wall of the at least one secondary battery is located and along the height direction of the at least one secondary battery, the at least one secondary battery is arranged above the heat exchange member, and
wherein the heat exchange member comprises a heat exchange channel, and at least part of the heat exchange channel is located in the at least one first recessed portion.

18. The battery pack according to claim 17, wherein the heat exchange member comprises a body portion and a second protruding portion, the second protruding portion is arranged at a side of the body portion facing the at least one secondary battery, at least part of the second protruding portion extends into the at least one first recessed portion, and at least part of the heat exchange channel of the heat exchange member is arranged in the second protruding portion.

19. The battery pack according to claim 18, wherein the at least one secondary battery comprises a second recessed portion, and second recessed portions of adjacent secondary batteries are in communication with each other, and
wherein the heat exchange member is provided with a third protruding portion that extends into the second recessed portion.

20. The battery pack according to claim 17, wherein the at least one at least one secondary battery comprises a plurality of secondary batteries, and the plurality of secondary batteries are in series connection, parallel connection, or parallel-series connection to form the battery module.
